(19) United States
(12) Patent Application Publication
(10) Pub. No.: US 2026/0080806 A1
(43) Pub. Date: Mar. 19, 2026

(54) COLLECTIBLE SLEEVER TOOL

(71) Applicant: Dan Gwiazdowski, Philadelphia, PA (US)

(72) Inventor: Dan Gwiazdowski, Philadelphia, PA (US)

(21) Appl. No.: 19/378,698

(22) Filed: Nov. 4, 2025

Related U.S. Application Data
(60) Provisional application No. 63/858,210, filed on Aug. 5, 2025.
(60) Provisional application No. 63/864,018, filed on Aug. 14, 2025.

(51) Int. Cl. G09F 1/12

(52) U.S. Cl. CPC G09F 1/12

(57) ABSTRACT

One embodiment of a collectible sleever tool. The tool is comprised of a semi-rigid core 3 of a paper material with each surface covered with a material layer 2 of soft, smooth, clear, archival-quality biaxially oriented polypropylene (BOPP), that when configured together comprises a collectible sleever tool 1. It can be used to help place a collectible card 4 into a collectible item protective sleeve 5. The tool provides for advantageous handling, movement, protection, and storage of collectibles. Other embodiments are described as shown.

### CROSS-REFERENCE TO RELATED APPLICATIONS

This application claims the benefit of provisional patent application Ser. No. 63/858,210, filed Aug. 5, 2025 by the present inventor(s), and of provisional patent application Ser. No. 63/864,018, filed Aug. 14, 2025 by the present inventor(s) which are incorporated by reference in their entirety.

### FEDERALLY SPONSORED RESEARCH

Not Applicable

### SEQUENCE LISTING OR PROGRAM

Not Applicable

### BACKGROUND OF THE INVENTION—FIELD OF ENDEAVOR

This invention relates generally to devices that aid in the safe insertion of collectibles into protective containers and sleeves, and as one example of many, such devices which are used with collectible trading cards.

### BACKGROUND OF THE INVENTION—BACKGROUND ART

Trading cards can be highly collectible and valuable items, deemed desirable based on a variety of factors. Often, these cards are manually inserted into generally available protective sleeves or containers that provide protection.

The insertion process introduces risk of damage to the cards. Edges of the protective sleeves can nick or mark the edges of cards. Corners can be dented while fitting the card in, and edges can scrape and damage the surface of cards. Any of these and other issues can significantly decrease their value and desirability. The risk of damage persists across collectors of all experience levels.

This risk of damage exists with other relatively flat collectibles that are stored in similar ways, such as paper items, photos, letters, maps, ephemera, comic books, graphs, and more.

They commonly need a means to more safely insert them into their protective devices. Generally available methods and products lack effectiveness and do not properly meet these needs.

### SUMMARY

In accordance with one embodiment a collectible sleever tool comprises a semi-rigid core of a polyvinyl chloride (PVC) plastic with each surface covered with a layer of soft, smooth, clear, archival-quality biaxially oriented polypropylene (BOPP).

The core and soft, smooth layers and any related characteristics can vary in material used, thickness, and size. Colors and copy printed onto the core's surface can be used to enhance usability either in instruction or with guide markers to aid in effective use.

Branding can be applied. The tool can be configured in varied sizes to aid in safety storage of many different item types and sizes.

Although the description above describes one embodiment, these should not be construed as limiting the scope of other embodiments but as merely providing descriptions of some elements of one embodiment.

### SUMMARY—ADVANTAGES

Accordingly several advantages of one or more aspects are as follows: to provide a flat, semirigid to rigid, smooth surface on which a collectible item can rest while it's guided into a protective holder. Two sleever tools can be used to more safely position the collectible item between them and guide it more safely into a protective holder. Additionally, the collectible item can be positioned a distance from the leading edge of the sleever tools, thereby protecting the corners, while the sleever tools come into contact with the protective sleeve first. This can make it much easier and safer to place collectible items into protective holders. This might include for collectors, archivists, museum staff, and many others. Other advantages of one or more aspects will be apparent from a consideration of the drawings and ensuing description.

### DRAWINGS—FIGURES

FIG. 1 shows a perspective view of the collectible sleever tool

FIG. 2 shows an elevation view of the collectible sleever tool

FIG. 3 shows an exploded view of the collectible sleever tool

FIG. 4 shows an elevation view of a trading card between two collectible sleever tools

FIG. 5 shows a perspective view of a trading card between two collectible sleever tools

FIG. 6 shows an elevation view of a trading card between two collectible sleever tools, sliding into a protective sleeve

FIG. 7 shows a perspective view of a trading card between two collectible sleever tools, sliding into a protective sleeve

FIG. 8 shows a section view of a trading card between two collectible sleever tools, sliding into a protective sleeve

### DRAWINGS—REFERENCE NUMERALS

1—collectible sleever tool
2—material layer
3—core
4—collectible card
5—collectible item protective sleeve
6—utility opening 1
7—utility opening 2
8—rounded corner

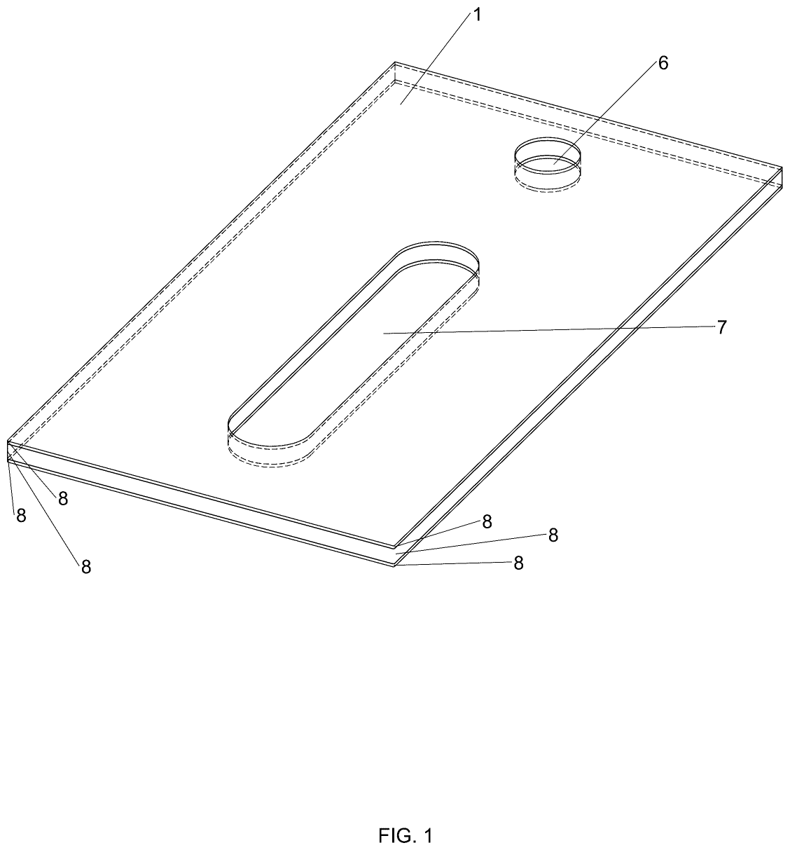

### DETAILED DESCRIPTION—FIGS. 1-8

One embodiment of the collectible sleever tool is illustrated in: FIG. 1. Said collectible sleever tool 1. In one embodiment, the tool can measure approximately 4.75″ tall×2.5″ wide×0.024″ deep, with rounded corners 8, a utility opening 6, and utility opening 7. However the tool 1 can be configured in other sizes, shapes, materials, and configurations. Corners 8 can be rounded as in one embodiment, or angled, beveled, or otherwise in other embodiments. Utility holes 6 and 7 can be different shapes or sizes. Additional utility holes can be included, or some, one, or none present.

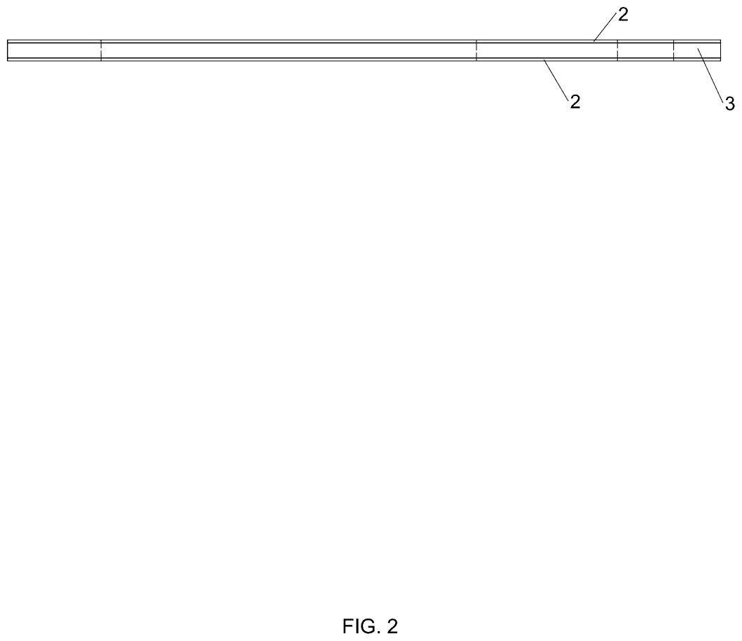

FIG. 2 shows an elevation view of one embodiment of the collectible sleever tool. The tool core 3 has a material layer on n 2 and on the bottom 2. In one embodiment the material layer 2 is an archival-safe, clear, biaxially oriented polypropylene (BOPP), measuring 2 mils in thickness. However, the material layer 2 can consist of any other low-friction substance, such as those that are smooth and soft.

In one embodiment the core 3 can be a polyvinyl chloride (PVC) plastic 0.02″ thick, where the material layers 2 can be laminated onto the core, with a combined thickness of 0.24″. Another embodiment can have the material layers 2 secured to the core 3 via adhesive or other appropriate bonding methods. Material layers 2 can also have performance enhancing coatings applied, for example, though not limited to, UV coating or slip-enhancers.

The core 3, prior to lamination, can be printed with graphics, copy, instructions, guides, branding, and any other relevant or visually aesthetic elements in a variety of colors.

Another embodiment can have the core 3 with just either the top or bottom covered with a material layer 2. Another embodiment can have a core 3 of sufficiently soft and smooth material, and no material layers 2. That face with the material layer 2 could then be used as the primary surface to come into contact with the item being to be protected.

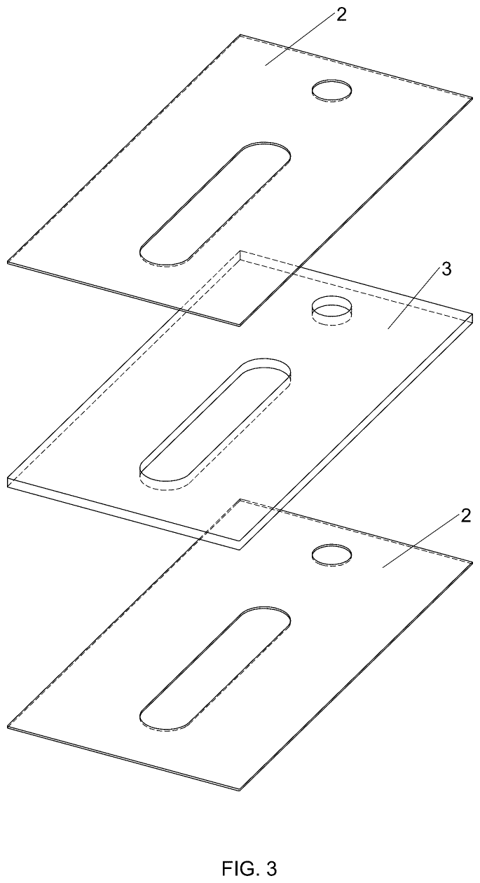

FIG. 3 shows an exploded view of the collectible sleever tool. It can be seen how the structural design of the material layer 2 fits on the top surface of the core 3, and on the bottom surface of the core 3 resulting in a smooth external surface profile. In one embodiment, the material layer is secured to only one side the core 3. In another embodiment, the material of the core 3 is paper. Generally, the core 3 rests between material layers 2 such that the outside surfaces that come into contact with collectibles will be soft and smooth. Many materials can be utilized in different embodiments for different use cases.

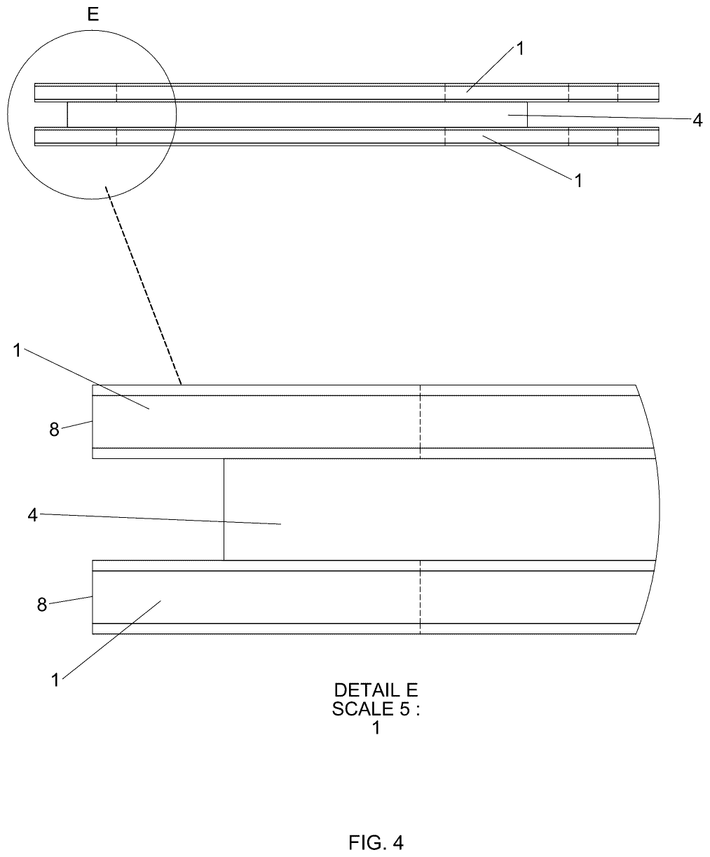

FIG. 4 shows an elevation view of a trading card 4 between two collectible sleever tools 1. A collectible trading card 4 is sandwiched between the smooth, soft surfaces of the sleever tools 1, allowing the collectible trading card 4 to be securely and safely handled, and moved as a single unit with the collectible sleever tools 1. Rounded corners 8 are noted and can help facilitate easier entry of the sleever tools into protective holders.

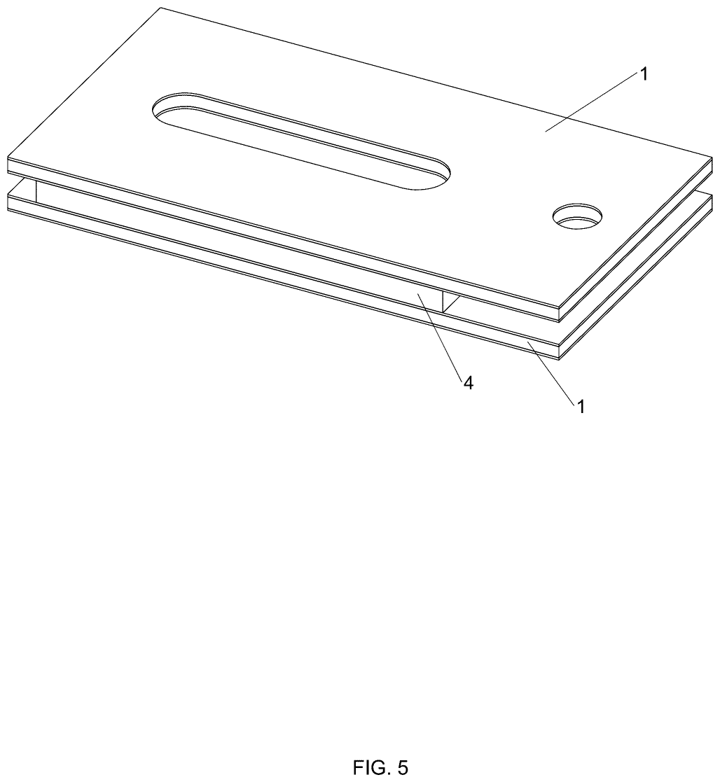

FIG. 5 shows a perspective view of a trading card 4 between two collectible sleever tools 1. A collectible trading card 4 is sandwiched between the smooth, soft surfaces of the sleever tools 1, allowing the collectible trading card 4 to be securely and safely handled, and moved as a single unit with the collectible sleever tools 1.

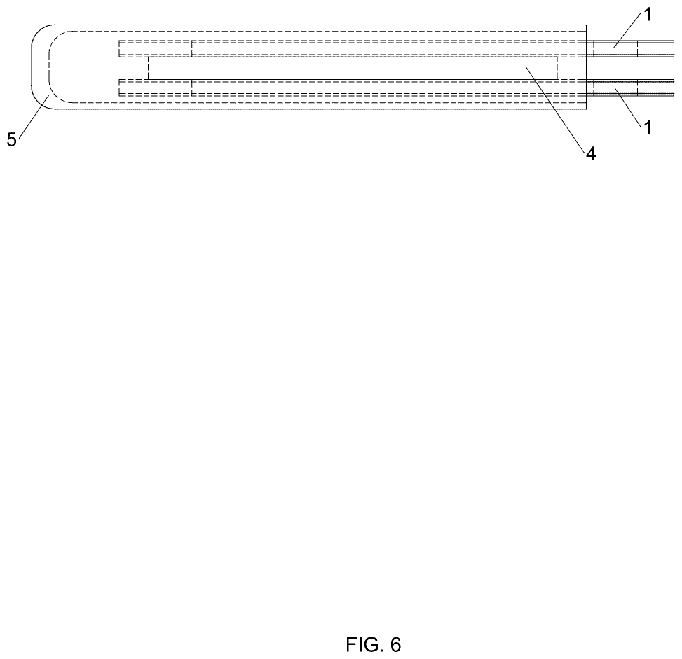

FIG. 6 shows an elevation view of a trading card 4 between two collectible sleever tools 1, sliding into a protective sleeve 5. Protective sleeves 5 are generally available and come in a variety of sizes for different collectibles. A collectible trading card 4 is sandwiched between the smooth, soft surfaces of the sleever tools 1, allowing the collectible trading card 4 to be securely and safely handled, moved as a single unit with the collectible sleever tools 1 into the opening of the protective sleeve 5. Often the corners and edges of the collectible trading card 4 come into contact with edges of the protective sleeve 5 and can cause damage. In this configuration, the collectible trading card 4 is sandwiched between the collectible sleever tools 1, and set back from their leading edges. The leading edges of the collectible sleever tools make contact first with the protective sleeve 5, guiding the unit of items (1 and 4 and 1) more safely into the protective sleeve 5. Since the edges and corners of the collectible sleever tools first make contact with the edges of the protective sleeve 5, it helps protect the collectible trading card 4 from having unnecessary contact with the protective sleeve 5. The overall size of the collectible sleever tool 1 can be larger than the collectible trading card, to allow the collectible trading card 5 to rest within the external edges of the collectible sleever tool 1, helping protect the collectible trading card 4. It could also be the standard with of a trading card, comic book, or any other item to be protected, such that it forms a layer group that is easy to pick up by its edges without much movement of the collectible.

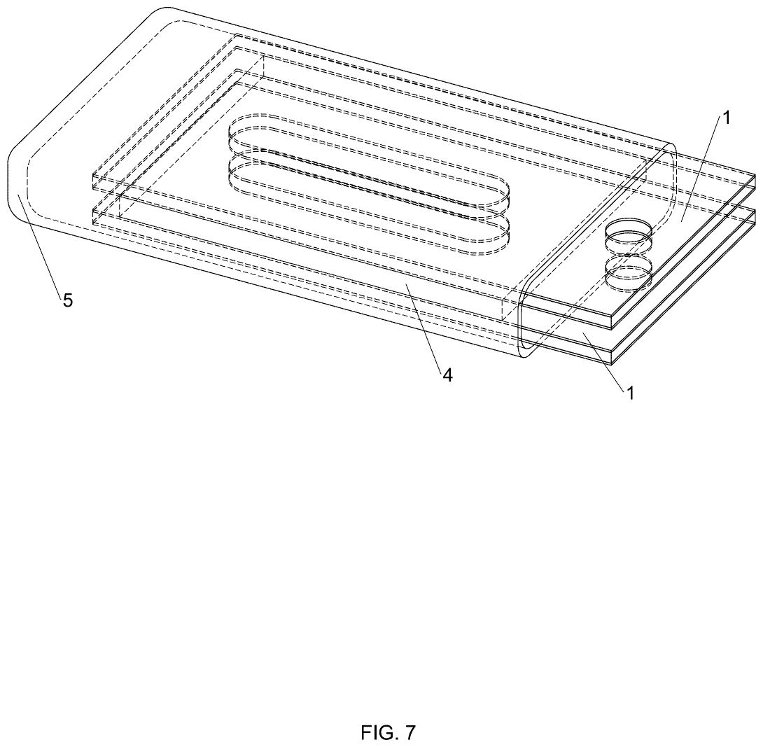

FIG. 7 shows a perspective view of a trading card 4 between two collectible sleever tools 1, sliding into a protective sleeve 5. Protective sleeves 5 are generally available and come in a variety of sizes for different collectibles. A collectible trading card 4 is sandwiched between the smooth, soft surfaces of the sleever tools 1, allowing the collectible trading card 4 to be securely and safely handled, moved as a single unit with the collectible sleever tools 1 into the opening of the protective sleeve 5. Often the corners and edges of the collectible trading card 4 come into contact with edges of the protective sleeve 5 and can cause damage. In this configuration, the collectible trading card 4 is sandwiched between the collectible sleever tools 1, and set back from their leading edges. The leading edges of the collectible sleever tools make contact first with the protective sleeve 5, guiding the unit of items (1 and 4 and 1) more safely into the protective sleeve 5. Since the edges and corners of the collectible sleever tools first make contact with the edges of the protective sleeve 5, it helps protect the collectible trading card 4 from having unnecessary contact with the protective sleeve 5. The overall size of the collectible sleever tool 1 is generally a little larger than the collectible trading card, to allow the collectible trading card 5 to rest within the external edges of the collectible sleever tool 1, helping protect the collectible trading card 4 edges and corners.

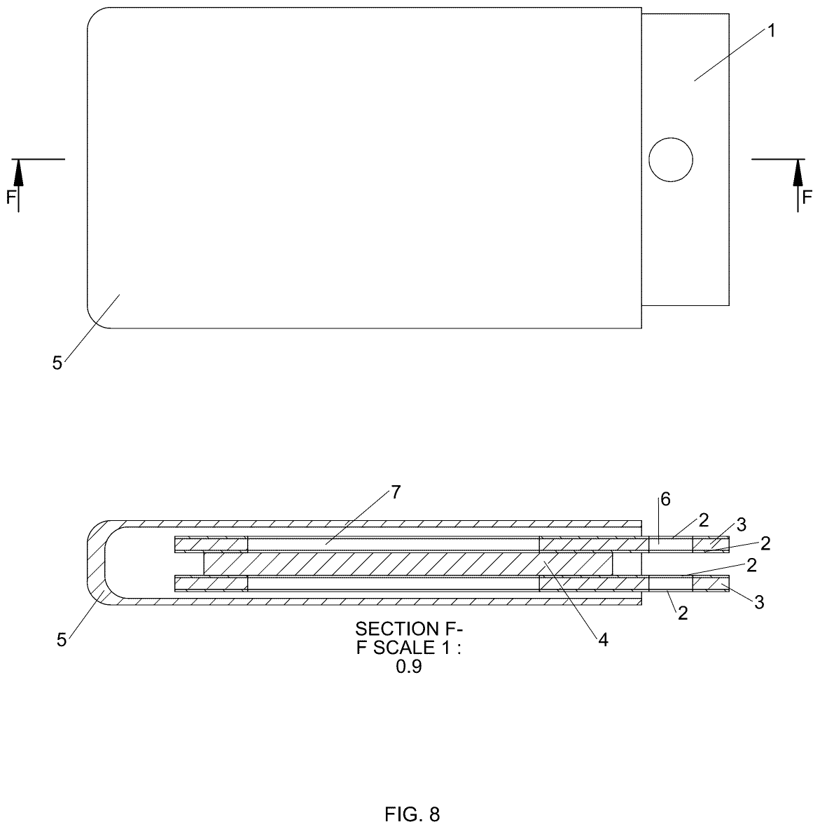

FIG. 8 shows a section view of a trading card 4 between two collectible sleever tools comprised of their components (material layer 2 and core 3), sliding into a protective sleeve 5. Protective sleeves 5 are generally available and come in a variety of sizes for different collectibles. A collectible trading card 4 is sandwiched between the smooth, soft surfaces of the sleever tools comprised of their components (material layer 2 and core 3), allowing the collectible trading card 4 to be securely and safely handled, moved as a single unit with the collectible sleever tools 1 comprised of their components (material layer 2 and core 3) into the opening of the protective sleeve 5. Often the corners and edges of the collectible trading card 4 come into contact with edges of the protective sleeve 5 and can cause damage. In this configuration, the collectible trading card 4 is sandwiched between the collectible sleever tools 1 comprised of their components (material layer 2 and core 3), and set back from their leading edges. The leading edges of the collectible sleever tools comprised of their components (material layer 2 and core 3) make contact first with the protective sleeve 5, guiding the unit of items (both sleever tools comprised of their components (material layer 2 and core 3) and the collectible trading card 4) more safely into the protective sleeve 5. Since the edges and corners of the collectible sleever tools comprised of their components (material layer 2 and core 3) first make contact with the edges of the protective sleeve 5, it helps protect the collectible trading card 4 from having unnecessary contact with the protective sleeve 5. The overall size of the collectible sleever tool comprised of their components (material layer 2 and core 3) is generally a little larger than the collectible trading card, to allow the collectible trading card 5 to rest within the external edges of the collectible sleever tool 1, helping protect the collectible trading card 4 edges and corners. Utility opening 6 can aid in the removal of the sleever tool by hand or other method. Utility opening 6 can also be used for other purposes, such as serving as a fixing point for a lanyard, key ring, hanging on a hook, or other functional use. Utility opening 7 can be used for functional purposes, in one example and embodiment to allow manual access to apply gentle friction in which to aid in the removal of the sleever while the collectible item, such as a collectible card, stays in place within the sleever.

### Operation

The manner of using the collectible sleever tool is generally as follows, and can vary based on embodiment. A collectible sleever tool 1 is placed on a flat surface, a collectible card 4 is placed on top of a material layer 2, offset from the leading edge that will be inserted into a protective sleeve 5, and a second collectible sleever tool 1 is placed on top of the collectible card 4 with material layer 2 facing the card. This makes a sandwiched card unit (as illustrated in FIG. 5).

The sandwiched card unit is then inserted into a protective sleeve 5 (as illustrated in FIG. 7). The leading edges and corners of the collectible sleever tools first make contact with the edges of the protective sleeve 5, helping to protect the collectible trading card's 4 corners and edges from having unnecessary contact with the protective sleeve.

Once the sandwiched card unit is of suitable distance in the protective sleeve 5, the collectible card collectible sleever tools 1 can be slid out from around the collectible card 4, using the utility opening 6 or grasping the top of the sleever tool 1. Since the collectible sleever tool 1 is comprised of a soft, smooth surface, it can safely slide out from between the protective sleeve 5 and collectible trading card 4.

If the sandwiched card unit is a tight fit within a protective sleeve or holder if otherwise preferred, once the sandwiched card unit is of suitable distance in the protective sleeve 5, the collectible sleever tool 1 towards the bottom can be slid out from underneath the collectible trading card 4, using the utility opening 6 or grasping the top of the sleever tool 1. Since the collectible sleever tool 1 is comprised of a soft, smooth surface, it can safely slide out from between the protective sleeve 5 and collectible trading card 4.

Next, the other collectible sleever tool 1 towards the top can be slid out from above the collectible trading card 4, using utility opening 6. Since the collectible sleever tool 1 is comprised of a soft, smooth surface, it can safely slide out from between the protective sleeve 5 and collectible trading card 4. If there is an amount of friction between the trading card 4 and the remaining sleever tool 1 such that the trading card 4 slides up and out along with the sleever tool 1, the trading card 4 can be gently grasped through utility opening 7, securing it in place while the sleever tool 1 is pulled up and out. If by the time the bottom of the utility opening 7 reaches the grasp point, such that it can not be fully removed with the grasp point blocking it, as this point there is suitable space below the sleever tool 1 such that the grasp point can be relocated below the sleever tool 1, thereby securing the trading card 4 in place while the sleever tool 1 can then be easily removed fully, if desired by grasping and pulling from the top area, or the utility opening 6.

Remaining will be the collectible trading card 4, inserted into the protective sleeve 5.

A collectible trading card 4 is now safely inserted into a protective sleeve 5, having its corners and edges protected by the collectible sleever tools 1.

If context or preference requires, one collectible sleever tool 1 can be used in some contexts rather than two.

### Additional Embodiments

The core 3 can be comprised of a paper material.

The core 3 can be comprised of a metal, carbon fiber, synthetic, leather, plastic, or other material.

The core 3 can be comprised of varied thickness across its surface.

The core 3 can be comprised of a material such that the material layer 2 is not incorporated.

The material layer 2 can be comprised of PVC plastic or other type of plastic.

The material layer 2 can be comprised of a polyester material.

The material layer 2 can be treated with additives to enhance performance and/or aesthetics.

The material layer 2 can be comprised varied thickness and/or texture across its surface.

The utility opening 1 6 can be comprised of various shapes and sizes, such as an oval, square, star, or other design.

The utility opening 2 7 can be comprised of various shapes and sizes, such as an oval, square, star, or other design.

The utility opening 1 6 and utility opening 2 7 can be comprised of various locations and shapes and sizes within the collectible sleever tool 1.

The collectible sleever tool 1 can be comprised of additional utility openings.

A collectible sleever tool 1 comprised of only one utility opening.

A collectible sleever tool 1 comprised of no utility openings.

The collectible sleever tool 1 can be comprised of rounded edges and/or corners.

The rounded corner 8 can be comprised of a smaller, or larger corner radius.

Another embodiment could inched a core comprised of a thick, semi-rigid core 3 that is strong, soft, and smooth enough as to not require an additional material layer 2 on its base(s) or surface(s).

Although the description above describes some embodiments, these should not be construed as limiting the scope of the embodiments but as merely providing descriptions of some embodiments. Other embodiments are possible.

### ADVANTAGES

From the description above, a number of advantages of some embodiments of the collectible sleever tool become evident:

(a) Can accommodate a wide variety of collectibles.
Collectibles by their very nature can be found in many variations. Some are small, large, thick, thin, strong, fragile, partially broken, torn, new, old, and in many different states and conditions. This tool can effectively accommodate many variations.

(b) Works with many collectible holder types.
Collectible holder types can vary in shape, size, material, thickness, and more. This tool can help securely insert collectibles into many holder types, some of which can include sleeves, savers, pages, loaders, bags, and many more.

(c) enables collectible storage opportunities for people with varying levels of physical dexterity.
Each person has a varying level of physical dexterity, of which might even change over time with age, health, and other factors. This tool makes it easier for many people with varying dexterity levels to insert collectibles into storage holders.

(d) Gentle on collectible surfaces.
Collectibles by their nature often have significant value associated with them, and in many cases sentimental and other value attributions. Condition is often key to that value and this tool, especially when embodied with a soft surface, helps to preserve the condition of collectibles when caring for and storing them.

(e) Helps protect the value of collectibles.
Often when caring for collectibles there is risk of damaging them when handling them. This tool helps to make handling safer and less risky, providing stability for collectibles, and also helping to protect their value especially during handling and when storing.

(f) Can integrate information onto the tool.
Graphics, guides, and visual elements can make the collectibles storage process much easier. This tool can include relevant information where its embodiment significantly improves the user experience, ease, and safety of collectibles storage.

(g) Creates branding and advertising opportunities.
The tool provides for and creates visual branding and advertising opportunities, which can be incredibly valuable in entities building brand equity, consumer awareness, and more. Marketing and advertising are large industries, and this tool introduces a unique new channel through which brand equity can be developed and a new channel through which to advertise.

(h) Makes protecting collectibles fast, easy, and consistent.
When it comes to handling valuable collectibles, this tool provides a way to consistently perform storage functions with repeatability, consistency, and predictability in that performance effectiveness. This is a significant advantage. For example when embodied with rounded corners one can experience less snagging and increased ease, speed, and consistency during the storage process.

(i) Easy, manual operation.
The tool can be used by hand, by most people, without the need for any specialized machinery, tools, training, or skill.

(j) Provides important support to a collectible while handling and storing.
Collectibles can be structurally supported and protected while used with the tool. Many collectibles are fragile and flexible, where the support this tool provides significant benefit to the safe handling of collectibles.

(k) Protects critical history.
Many collectibles, including though not limited to cards, tickets, photos, newspapers, magazines, letters, and maps provide a direct link to historical events that have shaped the world and its people. The collectible sleever tool provides a way to help protect that history and cultural significance in an efficient, effective way allows for more of that history to be preserved, learned from, valued, and appreciated.

Although the description above contains many advantages, these should not be construed as limiting the scope of the advantages but as merely providing descriptions of some of several advantages of some embodiments.

### CONCLUSION, RAMIFICATIONS, AND SCOPE

Accordingly, the reader will see that the collectible sleever tool can be efficiently and effectively used to aid in the safe insertion of collectibles into protective containers and sleeves. It is easy to use and can accommodate a variety of collectible item conditions, shapes, and sizes.

Although the description above contains many specifics, these should not be construed as limiting the scope of the embodiments but as merely providing descriptions of some of several embodiments. Many other variations are possible, for example, the tool can be of different sizes, the tool material layers can treated with performance-altering coatings, the components can be in different colors, the components made with different materials, etc.

Accordingly, the scope of the disclosure should be determined not by the embodiment(s) illustrated, but by the appended claims and their legal equivalents.

I claim:

1. A tool, comprising:
a. a figure comprised of a flat surface of sufficient size to accommodate a collectible item, and
b. a utility opening aperture through which contact can be made with said collectible item.

2. The tool of claim 1 wherein said figure is comprised of a core material covered with a material layer on one of its bases.

3. The tool of claim 1 wherein said figure is comprised of a core material covered with a material layer on each of its bases.

4. The tool of claim 1 wherein said tool comprises a utility opening aperture for manual manipulation of and hanging storage of said tool.

5. The tool of claim 1 wherein said surface is of sufficient size to accommodate a
standard trading card, said figure is comprised of a core material covered with a material layer on one of its bases, said tool comprises a utility opening aperture for manual manipulation of and hanging storage of said tool, the vertices of said tool are rounded corners.

6. The tool of claim 1 wherein said surface is of sufficient size to accommodate a
standard trading card, said figure is comprised of a core material covered with a material layer on each of its bases, said tool comprises a utility opening aperture for manual manipulation of and hanging storage of said tool, the vertices of said tool are rounded corners.

7. The tool of claim 1 wherein said surface is of sufficient size to accommodate a
standard trading card, said figure is comprised of a semirigid core material covered with a soft, smooth, archival-safe material layer on each of its bases, said tool comprises a utility opening aperture for manual manipulation of and hanging storage of said tool, the vertices of said tool are rounded corners.

8. A collectible sleever tool, comprising:
a. a figure core with bases of sufficient size to accommodate a collectible item
b. a material layer over the top base
c. a material layer over the bottom base
d. a utility opening aperture through said core and said material layers through which contact can be made with said collectible item
e. a utility opening aperture through said core and said material layers into which said tool can be manually manipulated, and
f. a plurality of rounded corners at the vertices of said collectible sleever tool.

9. The collectible sleever tool of claim 8 wherein the core is comprised of a semirigid material.

10. The collectible sleever tool of claim 8 wherein the core is comprised of a rigid material.

11. The collectible sleever tool of claim 8 wherein said material layers are comprised of a smooth material.

12. The collectible sleever tool of claim 8 wherein said material layers are comprised of a smooth archival-safe material.

13. The collectible sleever tool of claim 8 wherein said material layers are comprised of polypropylene material.

14. The collectible sleever tool of claim 8 wherein said utility opening aperture for contact is comprised of an oblong shape.

15. The collectible sleever tool of claim 8 wherein said utility opening aperture for manipulation is comprised of a circular shape and said utility opening aperture for manipulation can also be used to aid in storage of said collectible sleever tool.

16. The collectible sleever tool of claim 8 wherein said core is comprised of a paper material.

17. The collectible sleever tool of claim 8 wherein said tool measures 4.75″ tall×2.5″ wide×0.025″ thick, said core is comprised of paper material, said material layers are comprised of polypropylene material, said utility opening aperture for contact is a center-aligned oblong oval measuring 2.5″ long, said utility opening aperture for manipulation is a center-aligned circular shape measuring ⅜″ in diameter offset from the edge of said collectible sleever tool and the utility opening aperture for contact, the vertices of said collectible sleever tool are rounded corners, said core and said material layers are comprised of archival-safe materials.

18. A collectible sleever tool system, comprising:
a. a pair of flat semirigid figures with a material layer covering each of their bases of sufficient size to accommodate supporting a collectible item
b. a utility opening aperture in each said figure and said material layers through which contact can be made with said collectible item, and
c. said material layers are comprised of a soft, smooth material.

19. The collectible sleever tool system of claim 18 wherein said collectible sleever tool system comprises a utility opening aperture in each said figure and said material layers suitable for manual manipulation of and storage hanging of said collectible sleever tool system.

20. The collectible sleever tool system of claim 18 wherein said collectible sleever tool system comprises a utility opening aperture in each said figure and said material layers suitable for manual manipulation of and storage hanging of said collectible sleever tool system, said material layers are comprised of a polypropylene material, said figure is comprised of a paper material, and each said figure measures 2.5″ wide.
